(19) United States
(12) Patent Application Publication
(10) Pub. No.: US 2014/0363629 A1
(43) Pub. Date: Dec. 11, 2014

(54) THERMALLY COATED COMPONENT WITH A FRICTIONALLY OPTIMIZED RACEWAY SURFACE

(71) Applicant: DAIMLER AG, Stuttgart (DE)

(72) Inventors: Jens Boehm, Neuhausen (DE); Martin Hartweg, Erbach (DE); Tobias Hercke, Waldenbuch (DE); Patrick Izquierdo, Ulm (DE); Manuel Michel, Stuttgart (DE); Guenter Rau, Remseck (DE); Stefan Schweickert, Plochingen (DE)

(73) Assignee: DAIMLER AG, Stuttgart (DE)

(21) Appl. No.: 14/373,409

(22) PCT Filed: Dec. 21, 2012
(86) PCT No.: PCT/EP2012/005344

§ 371 Date: Jul. 21, 2014

(30) Foreign Application Priority Data
Feb. 11, 2012 (DE) 10 2012 002 766.4

(51) Int. Cl. C23C 4/04; G06F 17/50

(52) U.S. Cl. CPC C23C 4/04; G06F 17/5009
USPC 428/141; 428/411.1; 703/2

(57) ABSTRACT

A thermally coated component that has a frictionally optimized surface of a raceway for a frictional counterpart. The frictionally optimized surface has a theoretical oil retention volume V_{Oil} of 10 to 800 μm³/mm², which can be pre-determined by a component coating surface simulation. A method for the component coating surface simulation of a thermally coated component is furthermore disclosed, with parameter determination for surface structures of the component coating surface, wherein a parameter simulates a function between the component coating surface and the frictional counterpart.

The invention relates to a thermally coated component having a frictionally optimized raceway surface for a frictional counterpart.

It is known from the prior art to optimise the surface properties, such as friction, of components that interact with a frictional counterpart. Components of this type are, for example, the cylinder and piston pairing, the interaction of which is of the utmost relevance with respect to the overall performance of an internal combustion engine, in particular from an ecological and economic perspective. The oil consumption of an internal combustion engine is fundamentally determined by friction, which can be reduced by mechanical surface processing for the introduction of oil-retaining structures. Cutting methods such as honing, in particular laser honing and spiral slide honing, are considered as methods for this processing. Thus, microstructures are introduced as “bags”, in which the oil collects and forms a liquid film that allows the frictional counterpart to virtually float on top and thus reduces the friction to an ideal extent.

The surfaces of such surface-processed components, which interact with a frictional counterpart, often also have material-specific structures that arise, for example, during the production of a coating of the surface and that may be rather undesirable, and processing-specific structures that are beneficial for carrying out the surface processing in the desired manner. It can thus arise that an ostensibly surface-optimized component does not present the expected frictional properties.

Thermally coated components that conform to their genre are known from publications DE 102010049840 A1, DE 102009010790 A1 and DE 19628786 A1.

Based on this prior art, the object of the present invention is to create improved thermally coated components having a frictionally optimized surface of a raceway for a frictional counterpart, which have a reproducible and as pre-determinable an oil retention volume as possible, in order to achieve the desired running characteristics of the frictional counterparts.

This object is solved by a thermally coated component having the features of claim 1, which has a frictionally optimized surface of a raceway for a frictional counterpart.

Developments of the component are embodied in the dependent claims.

The object furthermore arises to create a method for the component coating surface simulation of a thermally coated component, which has a frictionally optimized surface of a raceway for a frictional counterpart.

Such a method is provided by the method having the features of claim 6.

The thermally coated component according to the invention has a frictionally optimized surface of a raceway for a frictional counterpart, which has an oil retention volume V_{Oil} of 10 to 800 μm³/mm².

The oil retention volume V_{Oil} does not have to be constant over the length of the raceway and/or the periphery thereof. The oil retention volume V_{Oil} is a combination of the oil retention volume of the frictionally optimized processing structure V_{Oil,Processing} and the oil retention volume of pores V_{Oil,Pores}.

In a preferred embodiment, the frictionally optimized surface of the raceway has an oil retention volume V_{Oil} of 50 to 200 μm³/mm².

The oil retention volume is advantageously a theoretical oil retention volume that can be predefined by a component coating surface simulation.

The surface processing of the frictionally optimized surface can advantageously be a mechanical, in particular cutting, process. Here, honing processing methods are considered, which are known in themselves to the person skilled in the art and which are carried out with a high level of precision; this also occurs on surfaces, as preferred according to the invention, which are thermal spray coatings, in particular coatings that are obtained by wire arc spraying or by the PTWA spraying method (Phase Transfer Wire Arc Spray Coating).

The component according to the invention can be, to name but a few components, a cylinder crankcase or a piston or a connecting rod or a bush such as a cylinder liner; these can essentially have any shape which may operate with low friction in a frictional counterpart or in which a frictional counterpart may operate with oil lubrication.

Advantageously, according to the invention, the theoretical oil retention volume V_{Oil}, which is to be between 10 and 800 μm³/mm², particularly preferably 50 and 200 μm³/mm², may be pre-defined by means of a component coating surface simulation.

Such a simulation serves for the functionally-relevant, simple, detailed and frictional counterpart-relevant analysis of surfaces.

In a first embodiment of the simulation method, the parameter determination of surface structures of a component coating surface therefore takes place, said surface being in operative connection with a frictional counterpart. Here, the parameter simulates a function between the component coating surface and the frictional counterpart. Therefore, the method enables, by using the parameters by means of simple modules using software technology, the functional behaviour of component coating surfaces to be simulated. There thus arises, from the method according to the invention, the possibility of creating functionally-relevant tolerances depending on the frictional counterpart of the surface that is to be analysed, and thus of optimising play between the contact partners.

The method comprises the following steps:

Firstly, the totality of the surface structures of at least one pre-determined section of the surface of the material is recorded by means of a profile depth determination method. It is represented as an overall profile, wherein the overall profile is recorded as a data set of profile depth values obtained along a line of intersection around a pre-determined measuring baseline, which is allocated to a respective position along the length of the measuring baseline. Then a mathematical morphological calculation programme is applied to the data set of the overall profile and thus the unrolling of a circle with a defined radius on the overall profile is simulated and an unrolling line on top of the overall profile is obtained, which simulates a contour flow of the contact partners on the tool surface. Now the calculation or integration of an overall surface that is delineated by the unrolling line and the overall profile takes place, as well as the definition of the overall surface as a first parameter.

In one development of the method, a second parameter is determined with the first parameter. This comprises the projection of the overall surface into the third dimension with respect to the material surface, and calculating an overall volume as the second parameter.

In a further development, the calculation of the overall surface comprises the determination of a difference between the unrolling line for each profile depth value and the determination of an individual surface between each profile depth value and a corresponding section of the unrolling line as a function of the position of the profile depth value along the line of intersection. Then the individual surfaces are added along the line of intersection.

Furthermore, the first parameter can be standardized in terms of the route and the second parameter can be standardized in terms of the surface. This advantageously serves for the establishment of a basis for comparisons etc. in the case of profile sections of various lengths.

Thus, the function-simulating first parameter can be a measurement for the amount of oil that is relevant for lubrication, and the second parameter projected therefrom can specify a theoretical oil retention volume of the component coating surface. The defined radius of the circle for determining the unrolling line, which for example corresponds to a theoretical flow contour of the piston ring, can be approximately 100 mm for this.

Further parameters can be determined, such as the oil volume of the cover, in particular the porosity, the median pore width and the median pore intersection from the pore profile.

In general, the component coating surface and the frictional counterpart form a static tightness system, in particular along a sealing bead of head gaskets on separating planes of the crankcase and cylinder head, wherein, here, the function-simulating first parameter specifies a theoretical sealing gap. The defined radius of the circle for determining the unrolling line, which corresponds to a theoretical contour flow of the sealing bead, can then be selected for the adjustment of various sealing designs and stresses; it can lie approximately in the range of 1 mm to 100 mm.

Furthermore, further parameters can be determined, in particular a maximum individual joint surface.

By applying the method, tolerances for the function-simulating parameters can be specified in technical product documentation and handling instructions for transgressions can be provided. An optical profile measuring method or a profile method, in particular a profile method according to ISO 3274, is particularly considered as a method for determining the profile depth.

Furthermore, the simulation method can comprise the determination of the parameters for processing and material-specific surface structures that are to be differentiated between. Here, the overall profile of the component coating surface is separated into a material-specific pore profile and a processing profile. The investigation and surface analysis methods known from the prior art evaluate, as a whole, the surfaces of components such as thermal spray coatings of the components according to the invention, for example a running surface of a cylinder piston, and thus no classification of features is possible for the instigator, for example an operator or coater, as to how they have the component surfaces according to the invention. These have passed through several production and/or processing steps in order to acquire their final surface condition. Therefore, with a differentiation method according to the invention for the differentiation of technical surface structures as regards their origin, the proportions of surface structures are to be determined.

The differentiation of the surface structures of the component processed with a surface processing method, having material-inherent surface roughness, for example a honed coating of a piston bearing surface of a cylinder, takes place as follows:

In order to be able to establish the reason of origin or the cause of the structures with regard to their type, a priori knowledge is taken as a basis in order that the structural proportions be able to be separated from one another. Then the structural proportions that have been separated from one another can be supplied for various evaluations.

To that end, after carrying out a profile depth determination method, the totality of the surface structures of a section of the coating surface of the component with material-inherent surface roughness is recorded and represented as an overall profile. The overall profile is compiled as a data set of profile depth values obtained along a line of intersection around a pre-determined measuring baseline.

Then, with the same profile depth determination method, the totality of the surface structures of a section of the surface of a surface-processed technical component that has no material-inherent surface roughness is recorded and represented as a processing profile. This is recorded as a data set of profile depth values obtained along a line of intersection around a pre-determined measuring baseline, which is allocated to a respective position along the length of the measuring baseline.

There then follows the determination of asymmetry of the frequency distribution of all processing profile depth values, which is characteristic for the surface processing method, and the definition of this asymmetry as a characteristic target asymmetry for the surface processing method.

Furthermore, a start line in the overall profile is determined, which runs parallel to the measuring baseline of the overall profile according to the deepest profile depth value, and a first asymmetry of the frequency distribution of the profile depth values of the overall profile, which are tangent to the start line, is determined on the start line. Then, intermediate lines between the start line and the measuring baseline, which are separated from one another, are defined in stages and, based on the start line, the asymmetries of the frequency distributions of the profile depths values of the overall profile, which are tangent to the corresponding intermediate lines, are determined successively.

Based on the start line, the determined asymmetries are compared with the target asymmetry. If the asymmetry of a specific intermediate line of the overall profile concurs with the target asymmetry, all profile depth values are selected that are tangent to this specific intermediate line. Then these profile depth values are represented as a pore profile. Through the selection, it occurs that the “processing profile” arising from the processing method is left over and is, in this respect, separated from the overall profile.

Thus, the structural separation is virtually enabled by the application of a priori knowledge, which is arrived at when a component that has no material-inherent surface roughness undergoes the same processing method as a component that does have surface roughness. It is, for example, investigated as to what characteristics a honed structured has in a component without pores and the separation of the honed structured in a component with pores is derived from this. The method thus enables the separate and targeted analysis of surface structures with attribution to the instigator.

The function-simulating first parameter as a measure for the oil quantity that is relevant for lubrication, and the second parameter projected therefrom, which specifies a theoretical oil retention volume of the material surface, can thus also be determined for respective overall, pore and processing profiles.

Furthermore, in a further embodiment of the method, the continuous representation of the pore profile of the selected profile depth values takes place. The pore profile is depicted particularly clearly when it is shown in a scale that differs from the scale of the measurement section of the overall profile, in particular an enlarged scale. The pores, and thus material unevenness or roughness, are then shown as being linked together, as well as the processing profile.

After the structural separation, both internationally standardized parameters (such as Rz, Ra in μm, ISO 4287) and the function-simulating parameters can be evaluated from the processing profile section and/or the pore profile section and can be used in the present simulation method. Here, the algorithms of the parameters are applied to the digitally present, structurally separated data sets of the processing profile section and/or the pore profile section.

In order to achieve a high level of definition with respect to the separation of the material and processing profiles, the spacing of the intermediate lines from one another and to the start line and the measuring baseline are in the range of 1 nm to 20 nm, preferably in the range of 5 nm to 15 nm and particularly preferably 10 nm.

The figures schematically illustrate the simulation and differentiation methods used for surfaces.

Here are shown:

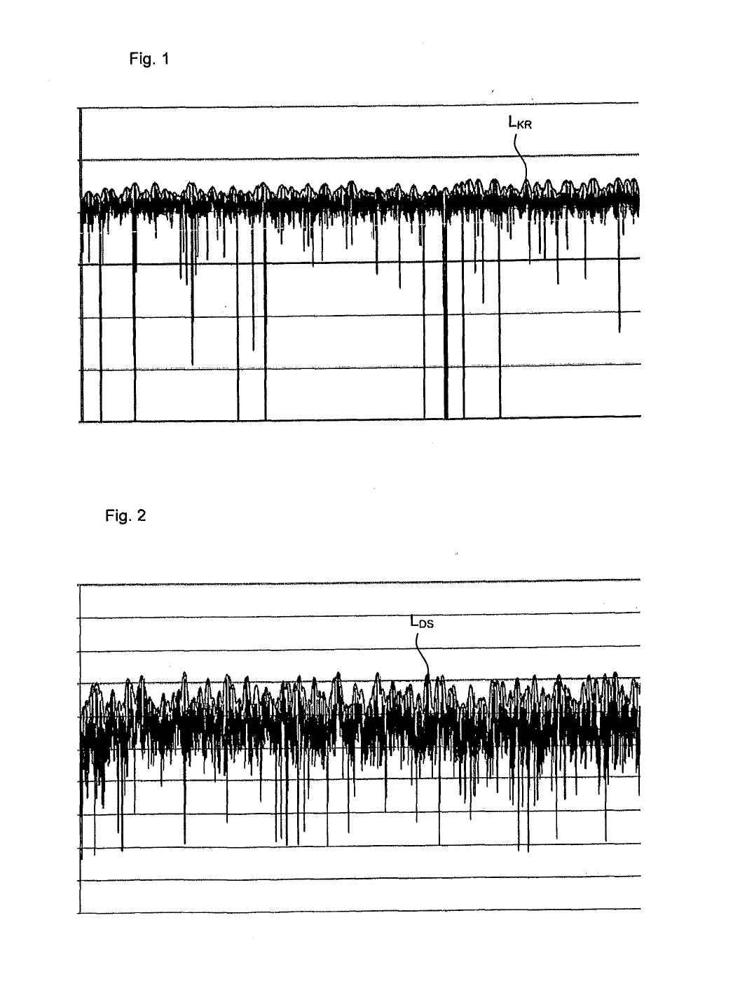

FIG. 1 a measuring profile of a processed, pore-afflicted cylinder raceway surface having the unrolling line generated according to the invention, which corresponds to a theoretical contour flow of the piston ring, for determining a theoretical overall oil retention volume as a parameter,

FIG. 2 a measuring profile of a crankcase/cylinder head surface having the unrolling line generated according to the invention, which corresponds to a theoretical contour flow of the sealing bead, for determining a theoretical sealing gap as a parameter,

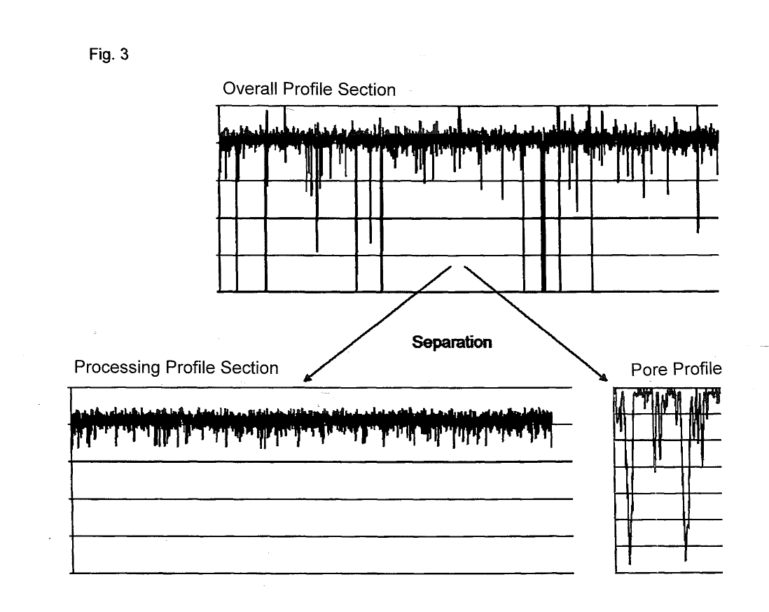

FIG. 3 the overall profile section of a processed, pore-afflicted component coating surface according to FIG. 1, as well as the processing profile section and the pore profile section separated therefrom for the determination of further parameters.

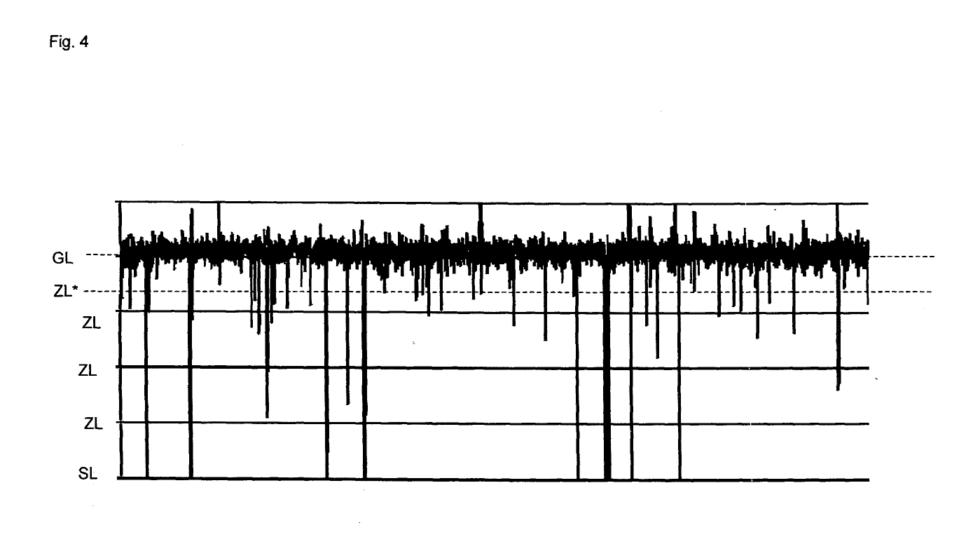

FIG. 4 the overall profile section from FIG. 3.

The simulation method serves for determining parameters for structures of component coating surfaces, which interact with a frictional counterpart, as illustrated in two examples: On the one hand, the determination of theoretical oil retention volumes and other function-simulating parameters for the cylinder raceway/piston ring components is carried out with the aid of FIG. 1, and, secondly, the determination of a theoretical sealing gap and other function-simulating parameters for static tightness systems (e.g. the sealing performance along a sealing bead of head gaskets on separating planes of a crankcase and cylinder head) is carried out with the aid of FIG. 2.

FIG. 1 illustrates the determination of the function-simulating parameters for the cylinder raceway/piston ring system. The difference between the theoretical flow contour L_{KR} of the piston ring and the surface profile measured on the cylinder raceway is the basis for the parameters of the “theoretical oil retention volume according to piston ring simulation”.

For this, V_{Oil,Total} in [μm²/mm³] denotes the theoretical oil retention volume that has been determined for the overall profile, as can be seen in FIG. 1. For a detailed assessment, the surface structures of the overall profile can be separated into a pore profile and a processing profile, as can be seen in FIG. 3. A theoretical oil retention volume based on processing structures V_{Oil,Processing} (in the case of honing of the bearing surface, V_{Oil,Honing}) in [μm²/mm³] can be determined from the processing profile, as well as a theoretical oil retention volume V_{Oil,Pores} in [μm²/mm³] based on the material-specific or coating-specific surface structures, such as pores, being determined from the pore profile.

Further parameters, which can in particular also be determined according to the structural separation, are a pore proportion [%], a median pore width [μm] and a median pore intersection [μm²]. A parameter V_{Oil,Cover} [μm²/mm³] describes a theoretical oil retention volume of a cover such as a cylinder cover, cylinder head cover or valve cover.

The basis for the parameter calculation of the processing-specific theoretical oil retention volume V_{Oil,Processing} is the separation of the material- and processing-specific surface structures. V_{Oil,Processing} is calculated from the processing profile (see FIG. 3), which is registered in the axial direction. The function of the piston ring flow on the raceway surface is simulated by a mathematically morphological method being applied to the digital data set of the corresponding profile, for example the overall profile (FIG. 1) in the calculation programme, said method simulating the unrolling of a circle with a defined radius, here 100 mm, on the profile. Here it is assumed that the unrolling line L₁ generated in this way is similar to the line of motion of the piston ring on the raceway. The gap between the unrolling line L_{KR} and the surface profile is a measure for the oil quantity relevant for lubrication or oil consumption. This measure is, for example, in the case of V_{Oil,Total}, calculated from adding up all individual joint surfaces as an overall surface and subsequent projection into the third dimension as a volume. In order to also achieve comparable results in the case of profile sections of different length, this calculated volume is standardized to 1 mm². The unit of V_{Oil,Total}, V_{Oil,Processing} and V_{Oil,Pores} is μm³/mm².

V_{Oil,Processing} and V_{Oil,Pores} are determined just as V_{Oil,Total}, though V_{Oil,Pores} on the pore profile and V_{Oil,Processing} on the processing profile are determined as is shown in FIG. 3, which are obtained from the structural separation of the overall profile.

FIG. 3 shows the separation of the structures caused by the component material (pore profile section) and the processing profile section generated by a processing method from an overall profile section of a processed, pore-afflicted component coating surface. The separated profile sections may be taken as a basis for the evaluation of the surface for the parameters determined according to the invention. The profile section of the surface is measured by an optical profile section or preferably by a profile method. Here, the profile depth values that differ from a measuring baseline are detected along a line of intersection.

In the case of mechanical profile methods, a probe tip is moved over the processed component coating surface at a constant speed. The measuring profile arises from the vertical positional displacement of the probe tip relative to the measuring baseline running parallel to the tool surface, said probe tip generally being detected by an inductive displacement measuring system. Here, the data set is obtained from the profile depth values along the measuring line.

The surface differentiation method that is illustrated in pictorial form in FIGS. 3 and 4 enables the structures caused by the material to be separated from the surface structures generated by a processing method, which can serve as a basis for the further evaluation of the surface.

As a basis for the separation of material and processing-caused surface structures, profile sections or measuring profiles are firstly made from processed component surfaces that have no pores and thus only display processed structures. Therefore, such a profile section may be used as a priori knowledge. The data set obtained, with the profile depth values, shall be the basis for the calculation of an asymmetry of the frequency distribution of the profile depth values. The asymmetry specifies the strength of the gradient of the statistical distribution of the profile depth values. The asymmetry determined with the pore-free component is typical of the respective processing method and describes the surface characteristics, such as symmetrical structures or structures that are plateau-like with different intensities, independent of the height characteristics of the structure, so independent of whether the processing was carried out coarsely or delicately. This asymmetry, which is typical of the processing method, is designed as a target asymmetry of the crucial parameters for the structural separation.

An optical or profile method carried out on a processed surface of a pore-afflicted material after obtaining a priori knowledge results in the overall profile section shown in FIGS. 3 and 4 from the profile depth values detected along the measuring line. To carry out the separation, a start line SL is now defined (cf. FIG. 4), which is located parallel to the measuring baseline GL at the deepest point of the measuring profile of the pore-afflicted tool surface, so is tangent to the deepest profile depth value.

In stages, starting from the start line SL, intermediate lines ZL are defined in the direction of the measuring baseline GL in pre-determined, preferably adjustable steps of, for example 10 nm, wherein, for each intermediate line ZL (potentially also for the start line SL), the asymmetry of the frequency distribution of the profile depth values is determined, which is tangent to the respective intermediate line (or start line SL). What are meant by “tangential profile depth values” are, in the present case, also the profile depth values that cut intermediate lines.

The asymmetry calculated with respect to each intermediate line ZL is compared to the target asymmetry. For the intermediate line ZL*, whose asymmetry corresponds to the target asymmetry, all structural valleys, so all profile depth values that are cut by the intermediate line ZL*, are selected by the measuring baseline GL, digitally based on the overall profile section, and are depicted coherently in a pore profile section (cf. FIG. 3). Here, however, the scale along the measuring line changes. The pore profile section reproduces the distribution of the pores along the measuring line and is typical for the material or the coating.

The overall profile is combined at the points at which the pore profiles have been removed, such that the processing profile section arises from the overall profile section, as is depicted in FIG. 3.

The separation method can be carried out automatically by a computer with corresponding algorithms, which enable the determination of the asymmetries, comparison of the asymmetries with the target asymmetry (which may be filed in a database) and the “sorting” of the profiles sections that the line ZL* cuts with a level of asymmetry that corresponds to the target asymmetry, as well as enabling its combination into the pore profile section and the creation of the processing profile section.

Both the pore profile section and the processing profile section may be the basis for the further evaluation of the surface. Here, the obtained pore profile section and the processing profile section are present as data sets which, as is shown in FIG. 3, may be depicted visually and/or may be used to calculate surface parameters.

Indeed, the surface structure separation does not in itself lead to the evaluation of the surface structures, but rather creates the conditions for a meaningful evaluation. The structural separation can, as described above, proceed automatically and can in particular also be adjusted for various processing methods (by determining the corresponding a priori knowledge). Thus the basis for the evaluation is achieved with parameters and standards. In a different manner from the hitherto known data pre-processing methods, such as filtering, even in the case of surfaces with extreme contrasts such as a highly refined processing in the presence of wide and deep pores, the method according to the invention does not lead to defects, as have so far occurred by covering the processing structure in the case of highly defined pores, whereby the evaluation of the processing structure with parameters was virtually impossible.

Further functional-simulating parameters are the relevant sizes for static sealing systems, for example the theoretical sealing gap that refers to the sealing properties along a sealing bead of head gaskets on the separating planes of the crankcase and cylinder head. The sealing gap is determined on the unfiltered surface overall profile by the unrolling line of a circle described above also being calculated here. Here, the radius is adapted to the properties of the seal. Thus, for example, a smaller radius of approximately 1 mm is selected in the case of several full beads and a thick coating of the metallic layer flat sealing, and a correspondingly larger radius is selected in the case of thinner coating. The gap between the calculated unrolling line and the surface overall profile is a measure for the seal that is to be expected. The sealing gap, denoted as parameter Df, is calculated by adding up all individual gap areas as a total area in μm². In order to also achieve comparable results in the case of profile sections of different length, this calculated area is standardized to 1 mm.

A further parameter from this family is Dfmax in μm². This is the largest individual gap area.

There is currently no interposition of human reasoning required for the parameter determination of the function-simulating parameters; the entire determination method proceeds automatically once the measured values and profiles have been input. One feature is the parametrisability (adaptability) to various sealing designs and stresses in the case of the parameters of the theoretical sealing gap.

For all function-simulating parameters, tolerances may be specified in technical product documentation. The action to be taken in case of transgression is, for example, dependent on the supplied documentation such as handling instructions.

In FIG. 2, the distances between the horizontal lines correspond to 1 μm; the width of the depicted measurement section corresponds to approximately 12 mm. The same units apply for the example in FIG. 1 of the V_{Oil,Total} depiction. It should be noted that the profiles in FIGS. 1 and 2 have different scales.

The measuring profile in FIG. 2 as a basis for the determination of the sealing gap is a measured, unfiltered profile (overall profile). Both the profile method (according to ISO 3274) and other, for example optical, profile section methods are considered as measuring methods. Simulation methods thus enable the function-related, simple, detailed and frictional counterpart-related evaluation of surfaces by parameters that simulate the functional properties in simple models using software technology. The surface evaluation thus takes place in close correlation with functional properties depending on the frictional counterpart. All known parameters only evaluate the observed surface as is, without reference to the frictional counterpart.

1. A thermally coated component, which has a frictionally optimized surface of a raceway for a frictional counterpart, wherein the frictionally optimized surface has an oil retention volume V_{Oil} of 10 to 800 μm³/mm².

2. The thermally coated component according to claim 1, wherein the oil retention volume is a theoretical oil retention volume predetermined by a component coating surface simulation.

3. The thermally coated component according to claim 1, wherein the frictionally optimized surface is mechanically processed.

4. The thermally coated component according to claim 1, wherein the thermal coating is a thermal spray coating.

5. The thermally coated component according to claim 1, wherein the component is a cylinder crankcase or a piston or a bush.

6. A method for the component coating surface simulation of a thermally coated component, which has a frictionally optimized surface of a raceway for a frictional counterpart, comprising the parameter determination for surface structures of the component coating surface, wherein a parameter simulates a function between the component coating surface and the frictional counterpart,
comprising the steps:
using a profile depth determination method, detecting the totality of the surface structures of at least one predetermined section of the surface of the component and depicting it as an overall profile, wherein the overall profile is recorded as a data set of profile depth values obtained along a line of intersection around a predetermined measuring baseline, which are allocated to a respective position along the length of the measuring baseline, and
applying a mathematical/morphological calculation programme to the data set of the overall profile, thus simulating the unrolling of a circle with a defined radius on the overall profile and obtaining an unrolling line (L_{KR},L_{DS}) over the overall profile, which simulates a contour flow of the frictional counterpart on the component coating surface,
calculating an overall area bordered by the unrolling line (L_{KR},L_{DS}) and the overall profile, and setting the overall profile as a first parameter.

7. The method according to claim 6, wherein a second parameter is determined with the first parameter, comprising the steps:
projecting the overall surface into the third dimension relative to the component coating surface and calculating an overall volume as the second parameter.

8. The method according to claim 6, wherein the calculation of the overall surface comprises:
for each profile depth value, determining a difference between the unrolling line and an individual surface between each profile depth value and a corresponding section of the unrolling line (L_{KR},L_{DS}) as a function of the position of the profile depth value along the line of intersection, and adding the individual surfaces along the line of intersection.

9. The method according to claim 6, comprising the step:
standardisation in terms of the route of the first parameter and standardization in terms of the surface of the second parameter.

10. The method according to claim 6, further comprising the step:
determining the parameters for processing and material-specifically differentiated surface structures, wherein the overall profile is separated into a material-specific pore profile and a processing profile.

11. The method according to claim 10,
wherein the differentiation of surface structures of a technical tool that has been processed with at least one surface processing method takes place, said tool having tool-inherent surface roughness,
comprising the steps:
using a profile depth determination method, detecting the totality of the surface structures of at least one predetermined section of the surface of the surface-processed technical material and depicting it as an overall profile, wherein the overall profile is recorded as a data set of profile depth values obtained along a line of intersection around a predetermined measuring baseline, which are allocated to a respective position along the length of the measuring baseline,
using a profile depth determination method, detecting the totality of the surface structures of at least one predetermined section of the surface of the surface-processed technical material that has no material-inherent surface roughness and depicting it as a processing profile, wherein the processing profile is recorded as a data set of profile depth values obtained along a line of intersection around a predetermined measuring baseline, which are allocated to a respective position along the length of the measuring baseline
and
determining an asymmetry level, which is characteristic for the surface processing method, of the frequency distribution of all processing profile depth values, and defining this asymmetry as a target asymmetry for the surface processing method,
then defining a start line in the overall profile, which runs parallel to the measuring baseline of the overall profile according to the deepest profile depth value,
determining a first asymmetry of the frequency distribution of the profile depth values of the overall profile on the start line, which are tangent to start line, and
defining, in steps, intermediate lines between the start line and the measuring baseline, which are spaced apart from one another, then
starting from the start line, successive determination of the asymmetries of the frequency distributions of the profile depth values of the overall profile that are tangent to the corresponding intermediate line,
successive comparison of all the asymmetries, starting from the start line, with the target asymmetry,
in the case of compliance between the asymmetry of a determined intermediate line of the overall profile and the target asymmetry, selecting all profile depth values that are tangent to the determined intermediate line, and
depicting the selected profile depth values as a pore profile, thus separating the processing profile from the overall profile.

12. The method according to claim 11, further comprising the step:
in a coherent manner, depicting the pore profile of the selected profile depth values and in a scale that differs from the scale of the measurement section of the overall profile, preferably an enlarged scale;
wherein the spacing of the intermediate lines from one another and to the start line and the measuring baseline is in the range from 1 nm to 20 nm.

13. The thermally coated component according to claim 3, wherein the frictionally optimised surface is mechanically processed by cutting, particularly preferably honed.

14. The thermally coated component according to claim 3, wherein the frictionally optimised surface is mechanically processed by honing.

15. The thermally coated component according to claim 4, wherein the thermal coating is an LDS coating or a PTWA.

16. The thermally coated component according to claim 5, wherein the component is a connecting rod or a cylinder liner.

17. The method according to claim 12, wherein the spacing of the intermediate lines from one another and to the start line and the measuring baseline is in the range from 5 nm to 15 nm.

18. The method according to claim 12, wherein the spacing of the intermediate lines from one another and to the start line and the measuring baseline is 10 nm.
